(19) United States
(12) Patent Application Publication
(10) Pub. No.: US 2008/0078333 A1
(43) Pub. Date: Apr. 3, 2008

(54) Pet hair thinning razor

(76) Inventor: Huo-Pia Wang, Chang-Hua City (TW)

Correspondence Address: TROP PRUNER & HU, PC, 1616 S. VOSS ROAD, SUITE 750, HOUSTON, TX, 77057-2631, US

(21) Appl. No.: 11/540,907

(22) Filed: Sep. 29, 2006

(51) Int. Cl. A01K 13/00

(52) U.S. Cl. 119/611

(57) ABSTRACT

A pet hair thinning razor includes: an elongate handle part extending in a first direction and having a connecting end; a comb part connected to the connecting end of the handle part and having a row of first comb teeth that are aligned in a second direction transverse to the first direction, each of the first comb teeth having a root portion and a tip portion opposite to the root portion; and a blade mounted on the comb part and having an edged lower portion that overlaps the root portions of the first comb teeth.

### BACKGROUND OF THE INVENTION

1. Field of the Invention

The invention relates to a pet hair thinning razor, more particularly to a pet hair thinning razor having a handle part and a row of comb teeth aligned in a transverse direction relative to the handle part.

2. Description of the Related Art

FIG. 1 illustrates a conventional pet hair thinning razor 10 adapted for combing and thinning hair of a pet 20, such as a dog, a cat, etc.

The pet hair thinning razor 10 includes a handle part 11, a comb part 12, and a blade 13. The handle part 11 extends in a first direction (I). The comb part 12 is connected to an end of the handle part 11 and has a row of comb teeth 121 aligned in a second direction (II) that is substantially parallel to the first direction (I). The blade 13 is mounted in a thin space in the comb part 12.

In use, the hair of the pet 20 is combed by the comb teeth 121 and is cut by the blade 13 at the same time.

The conventional pet hair thinning razor 10 has the following disadvantages:

1) Since the first and second directions (I), (II) are substantially parallel to each other and are substantially aligned in a vertical direction, the fingers of the user's hand, which holds the pet hair thinning razor 10, tend to be interfered by the pet's body, which results in inconvenience during combing and thinning operation.

2) The comb part 12 cannot be replaced with one having a larger size. As such, it will take longer time for combing and thinning the hair of the pet 20 having a large body size.

### SUMMARY OF THE INVENTION

Therefore, the object of the present invention is to provide a pet hair thinning razor that can overcome the aforesaid drawbacks associated with the prior art.

Accordingly, a pet hair thinning razor of this invention comprises: an elongate handle part extending in a first direction and having a connecting end; a comb part connected to the connecting end of the handle part and having a row of first comb teeth that are aligned in a second direction transverse to the first direction, each of the first comb teeth having a root portion and a tip portion opposite to the root portion; and a blade mounted on the comb part and having an edged lower portion that overlaps the root portions of the first comb teeth.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional pet hair thinning razor;

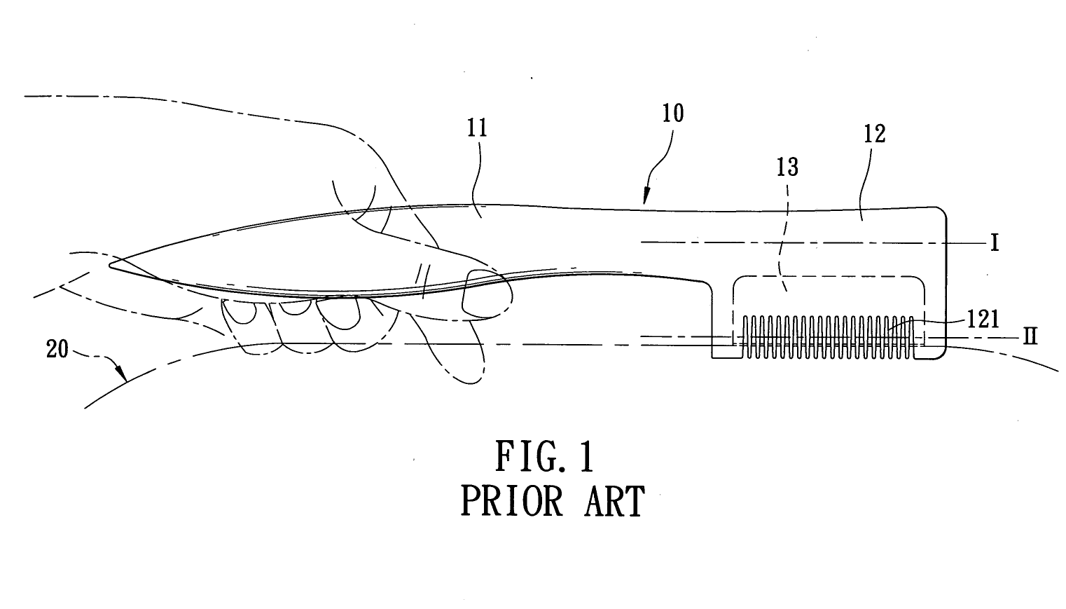

FIG. 2 is an exploded perspective view of the preferred embodiment of a pet hair thinning razor according to the present invention; and

FIG. 3 is an assembled perspective view of the preferred embodiment put in a state of use.

### DETAILED DESCRIPTION OF THE PREFERRED EMBODIMENT

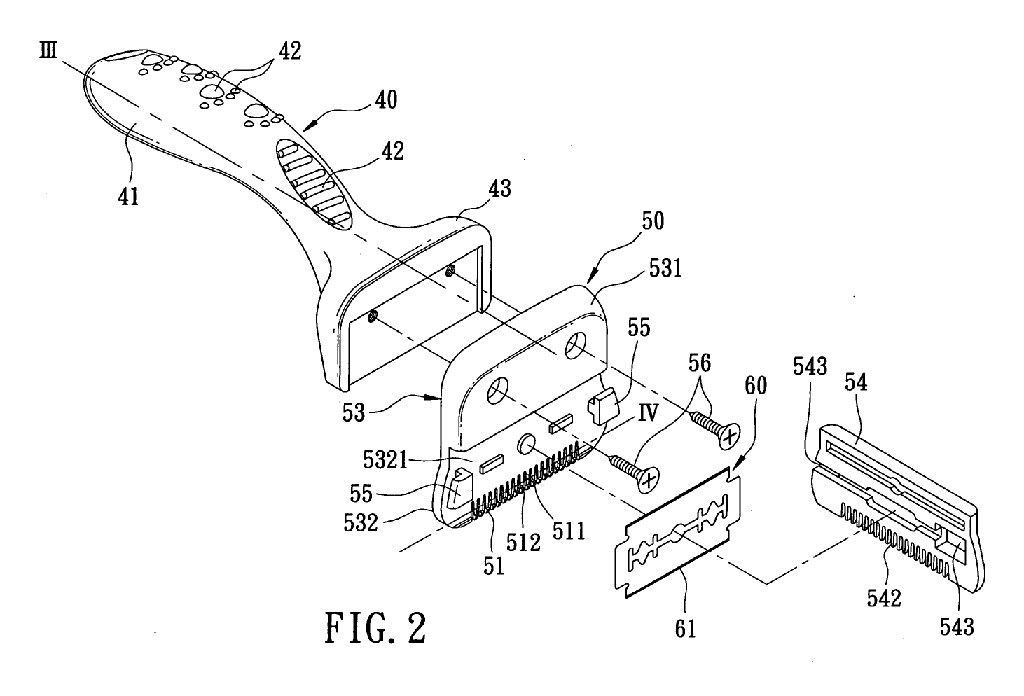

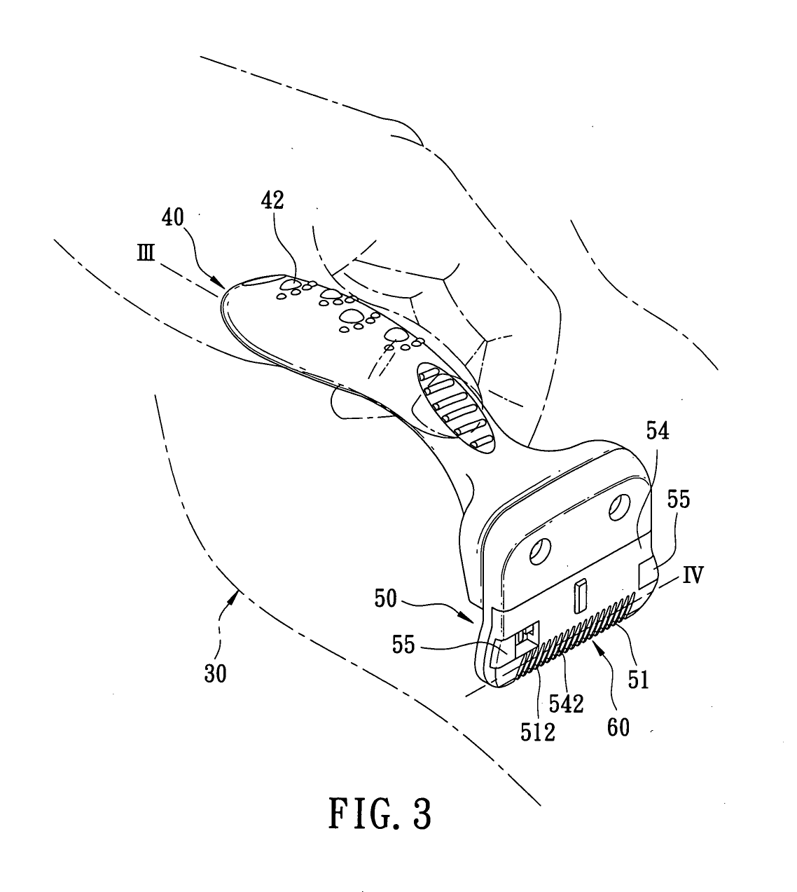

Referring to FIGS. 2 and 3, the preferred embodiment of a pet hair thinning razor according to the present invention is shown to include: an elongate handle part 40 extending in a first direction (III) and having a connecting end 43; a comb part 50 connected to the connecting end 43 of the handle part 40 and having a row of first comb teeth 51 aligned in a second direction (IV) transverse to the first direction (III), each of the first comb teeth 51 having a root portion 511 and a tip portion 512 opposite to the root portion 511; and a blade 60 mounted on the comb part 50 and having an edged lower portion 61 overlapping the root portions 511 of the first comb teeth 51.

In this embodiment, the comb part 50 is detachably secured to the connecting end 43 of the handle part 40 through fastening screws 56. The comb part 50 has first and second pieces 53, 54. The first piece 53 has an upper segment 531 connected to the connecting end 43 of the handle part 40, and a lower segment 532 that is transverse to the first direction (III) and that is formed with the first comb teeth 51. The lower segment 532 has a mounting surface 5321 for mounting of the blade 60 thereon. The second piece 54 is complementary to the lower segment 532 of the first piece 53 so as to sandwich the blade 60 therebetween.

The second piece 54 is formed with a row of second comb teeth 542 that are aligned in the second direction (IV) and that are respectively aligned with the first comb teeth 51.

The mounting surface 5321 of the lower segment 532 of the first piece 53 is formed with a pair of tongues 55. The second piece 54 is formed with a pair of grooves 543 that engage releasably and respectively the tongues 55 such that the second piece 54 is detachably connected to the first piece 53 and such that the blade 60 is pressed against the mounting surface 5321 of the lower segment 532 of the first piece 53 by the second piece 54.

To enhance gripping of the handle part 40, an outer surface 41 of the handle part 40 is formed with a plurality of anti-slip protrusions 42. In this embodiment, some of the protrusions 42 are semi-spherical in shape, and the remainder are semi-cylindrical in shape.

In use, as best illustrated in FIG. 3, since the first and second directions (III), (IV) are transverse to each other, and since a grip portion of the handle part 40 is distal from the comb part 50, the user's hand, which holds the pet hair thinning razor 10, is distal from the pet body 30, thereby preventing the fingers of the user from being interfered by the pet body 30 when combing and cutting the hair of the pet body 30. Moreover, the comb part 50 of the pet hair thinning razor 10 is replaceable and can have different sizes for different pet bodies.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pet hair thinning razor, comprising:
an elongate handle part extending in a first direction and having a connecting end;
a comb part connected to said connecting end of said handle part and having a row of first comb teeth that are aligned in a second direction transverse to the first direction, each of said first comb teeth having a root portion and a tip portion opposite to said root portion; and
a blade mounted on said comb part and having an edged lower portion that overlaps said root portions of said first comb teeth.

2. The pet hair thinning razor as claimed in claim 1, wherein said comb part is detachably secured to said connecting end of said handle part.

3. The pet hair thinning razor as claimed in claim 2, wherein said comb part has first and second pieces, said first piece having an upper segment connected to said connecting end of said handle part, and a lower segment that is transverse to the first direction and that is formed with said first comb teeth, said lower segment having a mounting surface for mounting of said blade thereon, said second piece being complementary to said lower segment of said first piece so as to sandwich said blade therebetween.

4. The pet hair thinning razor as claimed in claim 3, wherein said second piece is formed with a row of second comb teeth that are aligned in said second direction and that are respectively aligned with said first comb teeth.

5. The pet hair thinning razor as claimed in claim 4, wherein said mounting surface of said lower segment of said first piece is formed with a pair of tongues, said second piece being formed with a pair of grooves that engage releasably and respectively said tongues.

6. The pet hair thinning razor as claimed in claim 1, wherein said handle part has an outer surface formed with a plurality of anti-slip protrusions.
